(19) United States
(12) Patent Application Publication
(10) Pub. No.: US 2020/0076522 A1
(43) Pub. Date: Mar. 5, 2020

(54) METHOD FOR EMULATING A RADIO CHANNEL

(71) Applicant: AIT Austrian Institute of Technology GmbH, Wien (AT)

(72) Inventors: Markus HOFER, Neustadtl (AT); Thomas ZEMEN, Brunn am Gebirge (AT)

(73) Assignee: AIT Austrian Institute of Technology GmbH, Wien (AT)

(21) Appl. No.: 16/348,783

(22) PCT Filed: Oct. 25, 2017
(86) PCT No.: PCT/AT2017/060286

§ 371 Date: May 9, 2019

(30) Foreign Application Priority Data
Nov. 11, 2016 (AT) A51024/2016

(51) Int. Cl. H04B 17/391; G06F 17/50; G06F 17/16

(52) U.S. Cl. CPC H04B 17/3913; G06F 17/16; G06F 17/5009

(57) ABSTRACT

The invention relates to the emulation of a radio channel between moving transmitters and receivers with antennas. The relative position and relative movement and also the environment are used to ascertain propagation paths (P₀, P₁, . . . , P_{P-1}) running between the antennas, for which propagation paths a damping factor (ηₚ), a delay a delay (θₚ) and a Doppler frequency (vₚ) are separately ascertained. For each propagation path (P₀, P₁, . . . , P_{P-1}), table lookup for the delay and the Doppler frequency is used to produce a respective path matrix (ψₚ) that is weighted with the respective damping (ηₚ) of the propagation path (P₀, P₁, . . . , P_{P-1}), and all the path matrices are summed. The summed matrix (ψ) produced in this way is taken as a stating point for using a linear transformation to ascertain a transfer matrix (Y), the transformation reducing the dimension of the transfer matrix (Y) in comparison with the summed matrix (ψ) which corresponds to the coefficient vector (ε′ₚ) of the delay. The transfer matrix (Y) is transferred to a programmable circuit (20). In the programmable circuit (20), a number of discrete base functions characterising the time variance of an impulse response is prescribed, as base matrix (U). The signal of the transmitter is convoluted with the time-variant impulse response (h) by the digital circuit and in this way a discrete output signal (y) is produced.

The invention concerns a method for emulating a radio channel between a movable transmitter and a movable receiver, which are respectively connected to antennas, in a predeterminable environment influencing the radio channel.

From the prior art different emulation methods are known with which the behaviour of a radio channel can be emulated. The task of the invention is to provide a method which works with a low calculation time and is thus in the position to reproduce an emulation area in an especially precise manner.

The invention solves this task with a method of the aforementioned kind having the features of claim 1. Here, a method is provided for emulating a radio channel between a moving transmitter and a moving receiver which are respectively connected to at least one antenna, in a predeterminable environment influencing the radio channel, wherein for a number of consecutive time segments
respectively the relative position and relative movement upon which the emulation is based, and where appropriate relative orientation and relative rotation, of the two antennas to one another is predetermined, wherein the temporal change of the relative position and relative movement is predetermined in advance and in particular follows physical laws,
wherein on the basis of the relative position and relative movement and where appropriate relative orientation and relative rotation and on the basis of the predetermined environment a number of propagation paths running between the antennas is determined, wherein for each of the propagation paths a damping factor, a delay and a Doppler frequency are separately ascertained,
wherein starting from the individual propagation paths for a number of consecutive time segments in each case
   for each propagation path by means of separate table lookup for the delay and the Doppler frequency in each case one coefficient vector is produced and with these coefficient vectors by forming the Kronecker product a path matrix is produced, and the path matrices thus produced of the individual propagation paths are weighted with the respected damping of the propagation path and are summed,
   starting from the summed matrix thus produced by means of a linear transformation a transfer matrix is determined, wherein the transformation reduces that, in particular exclusively that, dimension of the transfer matrix with respect to the summed matrix which is equal to the coefficient vector of the delay, and
   the transfer matrix is transferred to the programmable circuit,
   wherein in the programmable circuit a number of discrete base functions is predetermined, characterising the time variance of the transfer functions and/or the impulse response, as base matrix,
   wherein the time-variable impulse responses of the respective time segment are determined by multiplying the transfer matrix with the base matrix,
   wherein the signal generated by the transmitter is sampled at an input and digitalised and in such a manner a discrete input signal is generated,
   wherein the discrete input signal is folded with a time-variable impulse response from a digital circuit and in such a manner a discrete output signal is generated, and
   that in particular starting from the discrete output signal a time and value continuous output signal is generated.

In order to be able better to describe the rise or fall of the damping during a time segment and in order to avoid artefacts occurring in the emulation, it can be provided
that for the individual consecutive time segments the damping for the individual propagation paths is predetermined with linear dependency on the discrete time, wherein as path parameters for the damping a constant term and a time-dependent term are predetermined,
wherein for each time segment and for each propagation path
   by means of separate table lookup of the delay a delay vector is produced and by means of separate table lookup of the Doppler frequency a Doppler vector is produced,
   on the basis of the Doppler frequency a further Doppler vector is produced, wherein the further Doppler vector is in particular produced:
      by means of table lookup in a further lookup table, or
      by means of determination on the basis of the following rule,

γₚ^{H}=U^{H}diag(m)Uγ′ₚ

wherein the matrix diag(m) describes a diagonal matrix in the diagonal entries of which are contained the entries of the vector m=[0, 1, . . . , M−1], the matrix U denotes the matrix of the base functions and the matrix U^{H} denotes the conjugated transpose of the matrix U,
the Kronecker product of the delay vector and the Doppler vector are formed and weighted with the constant term of the damping and,
the Kronecker product of the delay vector and the further Doppler vector is formed and weighted with the time-dependent term of the damping, and
the path matrix is calculated as sum of these Kronecker products.

In order to avoid artefacts which result on the basis of phase jumps, it can be provided
that for the individual time segments for each individual propagation path, in each case at the start of the actual time segment a present initial phase shift is kept available and in each case after the end of the time segment an initial phase shift is determined for the following time segment according to

ϕ_{p,S}=ϕ_{p,S-1}+v_{p,S-1}M

wherein v_{p,S-1} describes the Doppler frequency in the respectively preceding time segment and M specifies the length of the time segments, and
that in the determination of the path matrix for the individual propagation paths a phase correction is undertaken corresponding to the respective initial phase shift, in particular by weighting or multiplication with e^{jϕp,S}.

Several embodiments of the invention are shown in more detail with reference to the following drawing figures:

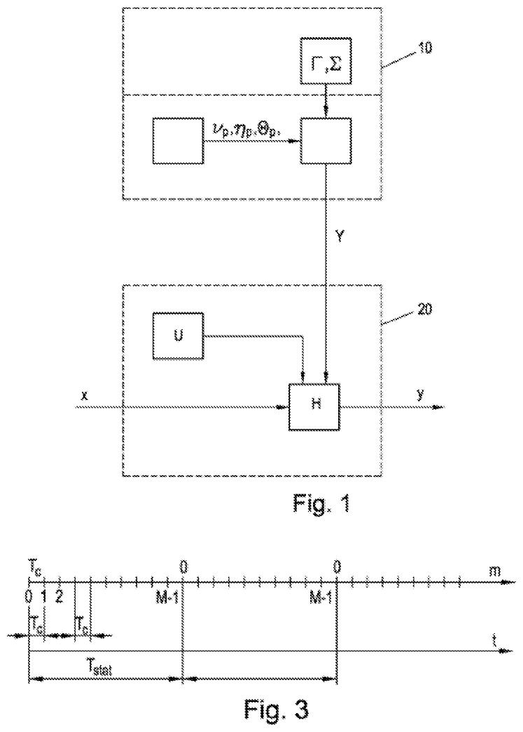

FIG. 1 shows in exemplary manner the construction of an emulation arrangement for carrying out the method according to the invention.

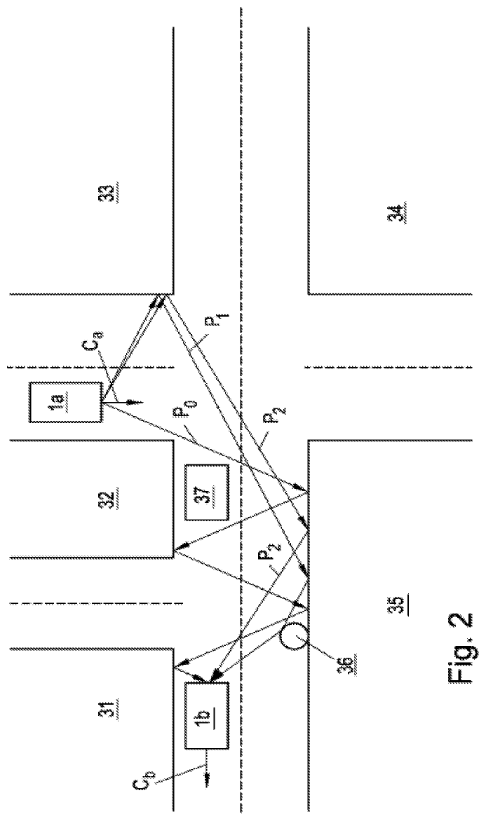

FIG. 2 shows an exemplary virtual environment, from which individual propagation paths can be concretely determined.

FIG. 3 shows schematically the chronological sequence.

### FIRST EMBODIMENT

Hereinafter, a first embodiment of the invention will be shown in detail.

### Hardware Setup

The purpose of the present method or of the arrangement shown in FIG. 1 is the emulation, i.e. copying, of the physical effects which result when a radio data transfer takes place between two usually travelling vehicles in the region of a road. Generally, however, there is the possibility of emulating channels between transmitters and receivers which move or change their position on any kind of devices, for example also ships, trains, aeroplanes, satellites et cetera. In addition, also in flexible production environments it is necessary to emulate the radio communication between moving transmitters and receivers. In particular when an actuator is equipped with a transmitter or receiver, the transmitting and receiving devices move with this actuator in space, such that the channel characteristics between the actuator and a communication partner change. In this regard, in particular effects are to be taken into consideration which result from the movement of the vehicles or devices with respect to one another, but also effects which result from objects or obstacles in the region of the roadway.

In the present embodiment example, for the emulation of the transfer behaviour, an arrangement is used which on the one hand comprises a simulation computer 10 and on the other hand a programmable circuit 20, in particular an FPGA. The simulation computer 10 and the programmable circuit 20 are in data connection with one another via a data interface.

In this connection it is significant that via the data interface it is not possible to transmit data with just any bandwidth, such that it is a great advantage when only low quantities of data are transmitted from the simulation computer 10 to the programmable circuit 20. In addition, it should also be noted that programmable circuits 20 in the form of FPGAs are able to carry out certain processes in parallel and at great speed.

The programmable circuit 20 has an analogue input, wherein an antenna signal is supplied to this input, which in actual use would ultimately be connected to the transmission antenna. Furthermore, the programmable circuit has an analogue output, wherein an antenna signal is applied to this output, which in actual use would ultimately be applied to the reception antenna.

Inasmuch as the programmable circuit has no analogue input or output, there is also the possibility of converting the incoming or outgoing signal from analogue to digital or digital to analogue.

### Specification of the Virtual Environment

In a first step, starting from a virtual area, shown in FIG. 2, the transfer behaviour between two antennas, disposed on vehicles 1a, 1b, located in the virtual area, is shown in more detail. In this regard, from a first vehicle 1a which has a transmitting antenna, electromagnetic waves are transferred to the vehicle 1b which has a receiving antenna. In the virtual area, there are in addition to the two vehicles 1a, 1b a number of objects or obstacles 31-37, the presence of which influences the wave propagation between the antennas on the vehicles. In this regard, these can be for example buildings 31-35, installations 36 located in the region of the street or other vehicles 37. Also other vehicles 37 can stay temporarily at different locations and influence the transmission behaviour between the transmitting antenna and the receiving antenna. This behaviour is to be considered individually in the context of determining the propagation paths P₀, P₁, P₂.

In the present case it is assumed that for the waves transmitted from the first vehicle 1a to the second vehicle 1b a multiplicity of propagation paths P₀, P₁, . . . , P_{P-1} are available which in each case have different propagation characteristics. In realistic simulations, the propagation paths P₀, P₁, . . . , P_{P-1} are characterised two-dimensionally or three-dimensionally, wherein between the two vehicles 1a and 1b, according to the required precision of the simulation, approximately P=100 to approximately P=5,000 propagation paths P₀, P₁, . . . , P_{P-1} are determined. According to required precision, the number of the propagation paths can however also be selected to be greater or smaller.

Since the emulation according to the invention also takes into consideration the alteration of the transmission channel in time, the individual propagation paths P₀, P₁, P_{P2} are in each case calculated anew at different points in time. In the present embodiment example of the invention, there is for example the possibility of calculating the propagation paths P₀, P₁, . . . , P_{P-1} in each case for entire individual time segments. The duration of the time segment τₛₜₐₜ (FIG. 3) can in the present embodiment example of the invention be fixed at between τₛₜₐₜ=1 ms and τₛₜₐₜ=10 ms, depending on expected movement speed of the vehicles. The individual movement paths Cₐ, C_{b} of the vehicles 1a, 1b and the orientation of the vehicles 1a, 1b are for this purpose entered in the form of piecewise defined movement paths Cₐ, C_{b}. For each vehicle 1a, 1b it is thus known at every point in time in which direction it moves and at which speed it moves. In addition, from the movement paths Cₐ, C_{b} available for the vehicles 1a, 1b also other geometrical parameters such as rotation speed, accelerations depending on the time etc. can be derived.

The specific movement path Cₐ, C_{b} can either be predetermined in advance or for its part be a result of a simulation of the driving behaviour of the vehicle 1a, 1b. Thus, the movement paths Cₐ, C_{b} can, for example as results of a driving dynamics simulation, be made available as initial values to a method according to the invention.

At the end of this step for a number of discrete points in time t or consecutive time segments there is in each case one virtual environment, in which there is respectively one first vehicle 1a having a transmitting antenna and one second vehicle 1b having a receiving antenna, and possibly further objects and obstacles. The vehicles 1a, 1b and the objects or obstacles can preferably move in the virtual environment.

### Path Parameter Determination

For each individual propagation path P₀, P₁, . . . , P_{P-1}, the damping factor ηₚ, the delay θₚ and the Doppler frequency vₚ are determined separately, wherein p lies between 0 and P−1 and specifies the index of the propagation path P₀, P₁, . . . , P_{P-1} concerned. This determination is based on the following considerations:

In order to facilitate a realistic modelling of the wave propagation, a geometry-based, stochastic channel model (GSCM) is assumed. The channel model is defined by a non-stationary transfer function g(t, f), which has at each point in time t a different frequency-dependent transmission behaviour, wherein the frequency is described by f.

$$g ( t , f ) = {g}_{Tx} ( f ) \underbrace{( {\sum }_{p = 0}^{P - 1} {η}_{p} ( t ) {e}^{- j 2 π {τ}_{p} ( t ) f} )}_{{g}_{Ph} ( t , f )} {g}_{Rx} ( f )$$

The transmission behaviour of the transmission and reception filters used can be represented by stationary transfer functions g_{Tx}(f) and g_{Rx}(f). The use of these transfer functions is however not further considered in the following.

The non-stationary time-dependent frequency response g(t, f) can be considered as a superimposition of path transfer functions g₀(t, f), . . . , g_{P-1}(t, f) of P individual propagation paths P₀, P₁, . . . , P_{P-1}.

The transmission behaviour of electromagnetic waves on each individual propagation path P₀, P₁, . . . , P_{P-1} can be described by means of a complex time-dependent damping coefficient ηₚ(t), which is predefined as follows:

ηₚ(t)=βₚ(t)e^{j2πϕ}^{ₚ}

Here, βₚ(t) represents a real amplitude, ϕₚ an initial phase shift and τₚ(t) a time-dependent delay.

In the course of the emulation, the non-stationary time-variable propagation process is approximated as piece-wise stationary, wherein the time segment, within which the respective function is considered stationary, is described with τₛₜₐₜ. It is assumed that within such a time segment τₛₜₐₜ the complex weight coefficients ηₚ(t) are unchanged: ηₚ(t)≈ηₚ. Furthermore, it is assumed that the relative speed between transmitting antenna and receiving antenna are constant during a time segment τₛₜₐₜ. Accordingly, the time-variable delay on the propagation path concerned is defined as follows:

$${τ}_{p} ( t ) = {τ}_{p} ( 0 ) - \frac{{f}_{p}}{f} t$$

In this context, τₚ(0) denotes the delay present at the beginning of the stationary interval, which is predetermined by the distance between transmitting antenna and receiving antenna. In this regard, fₚ denotes the Doppler frequency in the propagation path, which is defined as follows:

$${f}_{p} = {f}_{c} \frac{v cos ( {α}_{p} )}{{c}_{0}}$$

Here, f_{c} denotes the carrier frequency of the system, v the relative speed between transmitting and receiving antennas and αₚ the angle at which the respective propagation path arrives at the receiver. c₀ denotes the speed of light.

Subsequently, the channel transfer function g_{Ph}(t, f) is replaced with a discrete representation, wherein a discretised transfer function g[m,q] is predetermined which has a discrete time value m and a discrete frequency value q. In the case of a sampling rate τ_{C} (FIG. 3) of τ_{C}=1/(OSF•B) according to the time and a discretisation frequency Fₛ=0SF•B/N in the frequency there results

$$\begin{matrix}g [ m , q ] := {g}_{Ph} ( {mT}_{C} , {qF}_{s} ) \\ = {\sum }_{p = 0}^{P - 1} {η}_{p} {e}^{- j 2 π {θ}_{p} q} {e}^{j 2 π {v}_{p} m}\end{matrix}$$

Here, B denotes the system bandwidth which is selected to be smaller than the system bandwidth in the static case. M specifies the length of the stationarity area in time, OSF denotes the oversampling factor. The imaginary unit is denoted by j. Furthermore, the normalised Doppler frequency vₚ=fₚ τ_{C}/OSF is set. The value θp=τₚ(0)OSF/(Nτ_{C}) denotes the normalised delay, wherein |vₚ|<½ and 0<θₚ<1.

It should be noted that the discrete transfer function g[m, q] is admittedly fixed by means of the individual piece-wise constant path parameters ηₚ, vₚ, θₚ, but in the simulation computer this is not determined in a form in which it would be able to be used on a predetermined signal.

For characterising the transmission behaviour between the vehicle 1a and the vehicle 1b, for each individual propagation path P₀, . . . , P_{P-1} in each case the damping factor ηₚ, the delay θₚ and the Doppler frequency vₚ are determined, these parameters determine together the transmission behaviour of the respective propagation path P₀, . . . , P_{P-1}. For each time segment, thus, a number of path parameters ηₚ, vₚ, θₚ is determined separately in each case.

### Table Lookup

If all path parameters ηₚ, vₚ, θₚ are known for a predetermined time segment for the individual propagation paths P₀, . . . , P_{P-1}, on this basis a transfer matrix ψ is generated which characterises the total transfer behaviour of all propagation paths P₀, . . . , P_{P-1} and from which the transfer function g[m, q] can be derived with linear operations.

For this, a first lookup table ┌ is predetermined with which it is possible for each Doppler frequency vₚ to obtain a coefficient vector, hereinafter described as Doppler vector γ′ₚ, having in total Dₜ elements.

γ′ₚ=[γ′_{0,p}, γ′_{1,p}, . . . , γ′_{D}_{ₜ}_{-1,p}]^{T} ∈ [symbol] ^{D}^{ₜ}^{×1}

In the same way, a second lookup table Σ is predetermined, which permits for each delay θₚ the acquisition of a coefficient vector, hereinafter denoted as delay vector ε′ₚ, having in total D_{f} elements:

ε′ₚ=[ε′_{0,p},ε′_{1,p}, . . . , ε′_{D}_{ⱼ}_{-1,p}]^{T} ∈ [symbol] ^{D}^{ⱼ}^{×1}

In a variation of the invention, for the evaluation of the lookup tables ┌, Σ it can be provided that for a number of intervals, which together cover the respective value range of the path parameters θₚ, vₚ, in each case one Doppler vector γ′ₚ or one delay vector ε′ₚ is predetermined. In a preferred embodiment example of the invention, the value range of the normed Doppler frequency vₚ, which by reason of the previously mentioned norming is fixed at [−0.5, +0.5], and the value range of the normed delay θₚ, which is fixed at [0, 1], depending on the desired definition or precision, can be subdivided into approximately 1000 sub-ranges covering the entire value range and not overlapping. In this case, for each individual valid value for the Doppler frequency vₚ or for the delay θₚ in each case by means of table lookup respectively one Doppler vector γ′ₚ or delay vector ε′ₚ can be determined. Alternatively, also different sorts of interpolation can be used in order to obtain more precise results.

As a result of this table lookup, henceforth for each individual propagation path P₀, . . . , P_{P-1} and for each time segment, respectively, in addition to the path parameters ηₚ, vₚ, θₚ one Doppler vector γ′ₚ or delay vector ε′ₚ are available.

Calculation rules for the individual elements of the lookup tables are described in more detail in the following publications: F. Kaltenberger, “Low Complexity Simulation of Wireless Channels using Discrete Prolate Spheroidal Sequences,” PhD. dissertation, Technical University Vienna, May 2007; F. Kaltenberger, T. Zemen and C. W. Ueberhuber “Low Complexity Geometry-Based MIMO Channel Simulation”, Eurasip Journal on Advances in Signal Processing, vol. 2007, no. 1, p. 095281, 2007, doi: 10.1155/2007/95281.

### Determining the Lookup Values

In the previous step, the table lookup was described for determining the Doppler vector γ′ₚ and the delay vector ε′ₚ. Hereinafter, a possibility is shown for determining the individual values of the lookup tables concerned.

As already mentioned, the previously described time-variable transfer function g[m, q] is supposed to provide the frequency-dependent transfer behaviour at each point in time within the time segment concerned. For the following considerations, it is assumed that the time-variable transfer function g[m, q] is shown as a weighted sum of products of first base functions u₀[m], . . . , u_{Dt-1}[m] according to the discrete time m and second base functions v₀[q], . . . , v_{Df-1}[q] according to the discrete frequency q. Both the first time-variable base functions and the second frequency-variable base functions arise in each case from a predetermined discrete function space. The individual discrete values of the first and second base functions are complex numbers. The individual discrete values of the first and second base functions are complex numbers.

In particular, the entirety of the Dₜ first base functions u₀[m], . . . , u_{Dt-1}[m] can be shown as a first base matrix U, the elements of which are determined according to U_{i,m}=uᵢ[m]. In the same way the entirety of the D_{f} second base functions v₀[q], . . . , v_{Df-1}[q] can be shown as a second base matrix V, the elements of which are determined according to V_{i,1}=vᵢ[q].

Preferably, as first and second base functions, Slepian functions are used, which can also be described as “discrete prolate spheroidal sequences” (DPS). Such Slepian functions are for example known from the publication D. Slepian, “Prolate Spheroidal Wave Functions, Fourier Analysis and Uncertainty-V: The Discrete Case”, Bell System Technical Journal, vol. 57, no. 5, pp. 1371-1430, May 1978, doi: 10.1002/j.1538-7305.1978.tb02104.x.

On the basis of the modelling assumption regarding the propagation characteristics in the individual propagation paths, a representation can be found in which the time-dependent part g^{t}ₚ[m] and the frequency-dependent part g^{f}ₚ[q] of the path transfer function and the time-independent and frequency-independent damping is shown as a product

gₚ[m, q]=ηₚe^{-j2πθ}^{ₚ}^{q}e^{j2πv}^{ₚ}^{m}=ηₚgₚ^{f}[q]gₚ^{t}[m]

The discrete values of the path transfer function gₚ[m, q] can be shown as path transmission matrix Gₚ. The time-dependent discrete function g^{t}ₚ[m] and the frequency-dependent discrete function g^{f}ₚ[q] can be shown in each case as vectors g^{t}ₚ, g^{f}ₚ, wherein g^{t}ₚ is a column vector having the length M and g^{f}ₚ is a column vector having the length N. The path transmission matrix Gₚ can as a Kronecker product of the two discrete functions g^{f}ₚ[q], g^{f}ₚ[m] multiplied with a constant damping term ηₚ be shown as follows:

Gₚ=ηₚgₚ^{f}gₚ^{tτ}

wherein τ represents the transpose. Both the time-dependent part

gₚ^{t}[m]=e^{j2πp}^{ₚ}^{m}

and the frequency-dependent part

gₚ^{f}[q]=e^{-j2πθ}^{ₚ}^{q}

can be approximately shown separately by means of weighted sums of first and second base functions.

u₀[m], . . . , u_{D}_{ₜ}₋₁[m]; v₀[q], . . . , v_{D}_{ⱼ}₋₁[q]

Accordingly, the vectors g^{t}ₚ g^{f}ₚ can be represented as weighted sums of the row vectors of the base matrices U, V.

The individual elements of the Doppler vector γ′ₚ and the delay vector ε′ₚ now specify how the individual row vectors of the base matrices U, V are respectively to be weighted, in order to obtain the vectors g^{t}ₚ g^{f}ₚ.

If one uses the determined elements γ′_{0,p}, . . . , γ′_{Dt-1,p} of the Doppler vector γ′ₚ at a later point in time as weights for the individual Slepian functions S₀[m], . . . S_{Dt-1}[m], one obtains when executing a weighted sum an approximated value g^{t}ₚ[m] for the time-dependent part g^{t}ₚ[m]=e^{j·2π·vp·m} of the model acceptance.

$${g}_{p}^{t} [ m ] \text{\textasciitilde} {\underline{g}}_{p}^{t} [ m ] = {\sum }_{i = 0}^{{D}_{t} - 1} {γ}_{i , p}^{′} {S}_{i} [ m ]$$

The individual values of the Slepian functions S₀[m], . . . , Sᵢ[m], . . . S_{Dt-1}[m] can be conceived and represented as a matrix U_{i,m}.

If one uses the determined elements ε′_{0,p}, . . . , ε′_{Df-1,p} of the delay vector ε′ₚ at a later point in time as weights for the individual further Slepian functions S′₀[q], . . . S′_{Dt-1}[q], one obtains when executing a weighted sum an approximated value g^{f}ₚ[q] for the frequency-dependent part g^{f}ₚ[q]=e^{-j·2π·0p·q} of the model acceptance.

$${g}_{p}^{f} [ q ] \text{\textasciitilde} {\underline{g}}_{p}^{f} [ q ] = {\sum }_{i = 0}^{{D}_{f} - 1} {ϵ}_{i , p}^{′} {S}_{i}^{′} [ q ]$$

The individual values of the further Slepian functions S′₀[q], . . . , S′ᵢ[q], . . . , S′_{Df-1}[q] can be conceived and represented as a matrix V_{i,q}.

Determining the Transfer Matrix

Hereinafter, the determining of a transfer matrix Y will be shown in detail, wherein for each time segment respectively one separate transfer matrix Y is produced. Each transfer matrix Y is valid respectively within a discrete time segment. The present method has the special advantage that the storage space required for the representation and storage of the transfer matrix Y is independent of the number P of the propagation paths P₀, . . . , P_{P-1} determined in the context of the simulation.

In a first step, for each propagation path P₀, . . . , P_{P-1} individually one path matrix ψₚ is determined, which is equal to the Kronecker product of the Doppler vector γ′ₚ and the delay vector ε′ₚ multiplied by the scalar damping coefficient ηₚ. The path matrix ψₚ has in each case D_{f} columns and Dₜ rows, its entries are in each case complex numbers. The path matrix ψₚ is specified by the following rule, wherein the symbol ⊗ denotes the Kronecker product:

Ψₚ=ηₚ·γ′ₚ⊗ε′ₚ^{τ}

By summing the individual path matrices ψₚ, one obtains the summed matrix ψ, the entries of which are specified as follows:

$$Ψ = {\sum }_{p = 0}^{P - 1} {η}_{p} \cdot {γ}_{p}^{′} ⊗ {ϵ}_{p}^{′ T}$$

The summed matrix ψ has respectively D_{f} columns and Dₜ rows, its entries are in each case complex numbers. It should be noted that by reason of the summing across the in total P propagation paths, the complexity in the simulation computer is linearly dependent on the number P of the propagation paths, but that the further processing is however independent of the number P of the propagation paths used for the formation of the summed matrix ψ.

Furthermore, a Fourier transformation matrix W is predetermined, the elements [W]ᵢⱼ of which are specified as follows:

$${[ W ]}_{i , j} = \frac{1}{\sqrt{N}} {e}^{\frac{- j 2 π ( i - 1 ) ( j - 1 )}{N}} ∈ {ℂ}^{N \times N} , \\ ∀ i , j ∈ \{ 1 , … , N \}$$

Subsequently, a matrix D is predetermined as a submatrix of the matrix W, which has only the first N×L rows or columns of the Fourier transformation matrix W.

With this Fourier transformation matrix D it is possible, on the basis of a discrete transfer function g[m, q], the arguments of which represent a discrete time variable m and a discrete frequency variable q, to determine a purely time-based transfer function h[m, l], wherein m represents the point in time of the signal value of the input signal, the effects of which are to be observed at the point in time m+l. If one considers the two two-dimensional discrete functions h[m, l] and g[m, q] as matrices G, H of the function values concerned, there exists the relationship:

H=D^{H}G.

Here, the frequency-dependent vectors g[m] of the matrix G are transformed into time-delay-dependent vectors h[m] of the matrix H. Furthermore, if one assumes that the matrix G of the transfer function can represent on the basis of the predetermined base functions and the summed matrix ψ with G=V ψ^{τ}U^{τ}, thus the matrix H can be defined for the representation of the purely time-dependent transfer function h[m, l], according to

$$\begin{matrix}H = {D}^{H} G \\ = {D}^{H} V {Ψ}^{T} {U}^{T} \\ = {V}^{′} {Ψ}^{T} {U}^{T} \\ = {YU}^{T}\end{matrix}$$

the transfer matrix Y results here as product D^{H} V W^{τ}. This product can on the one hand be formed in that the summed matrix ψ is formed as previously described and subsequently multiplied with a previously pre-computed matrix V′=D^{H}V. The transfer matrix Y has in each case Dₜ columns and L rows, its entries are in each case complex numbers.

Transmitting the Transfer Matrix

While the previously mentioned steps are all executed in this simulation computer, i.e. on a PC, workstation etc., the step described hereinafter of the determination and use of the transfer function g is carried out on the programmable circuit. For each discrete time segment, one transfer matrix Y is transferred from the simulation computer to the programmable circuit and cached by it.

Determining the Transfer Function

As already mentioned in connection with the determining the entries of the lookup tables, the transfer function h[m, l] is shown as a discrete two-dimensional function h[m, l] or as a matrix H. The matrix H representing the transfer function h[m, l] can, as already mentioned, be shown as a product H=Y U^{τ} of the transfer matrix Y with the first base matrix U, which contains discretely evaluated function values of the Slepian functions Sᵢ(m)=U_{i,m}. The values of the first base matrix U are stored in a programmable circuit. If one multiplies the transfer matrix Y, newly specified for each time segment, with the first base matrix U which is per se temporarily immutable, one obtains the matrix H of the transfer function. The matrix H has respectively M columns and L rows, its entries are in each case complex numbers. Analogously, the transfer function h[m, l] can be determined according to the following relationship.

$$h [ m , l ] = {\sum }_{i = 0}^{{D}_{t} - 1} ϒ [ l , i ] {S}_{i} [ m ]$$

It is to be noted that the transfer function h[m, l] can be determined in a simple manner using vector operations which is as a rule available for programmable circuits such as FPGAs.

Using the Transfer Function

Hereinafter, the usage of the transfer function H on the input signal x[m] concerned is shown. In this regard, for the time segment concerned of a time duration of τₛₜₐₜ, in each case at M sampling times, values at the input are determined and digitalised and combined to form a vector which represents the input signal x[m]. It is assumed that the input signal x[m] is present in digital or digitalised form, wherein m represents a discretised time parameter which runs in the time segment concerned between 0 and M−1. Also the output signal y[m] to be determined is to be discretely defined on the same M sampling time points within the time segment τₛₜₐₜ.

For the specific determination of the output signal y[m] at a discrete point in time m, only the last L values of the input signal x[m] are used:

$$y [ m ] = {\sum }_{i = 0}^{L - 1} h [ m - l , l ] x [ m - l ]$$

For a simplified example with L=3, there results the following procedure for determining the output signal

$$y [ 0 ] = x [ 0 ] h [ 0 , 0 ]$$

$$y [ 1 ] = x [ 1 ] h [ 1 , 0 ] + x [ 0 ] h [ 0 , 1 ]$$

$$y [ 2 ] = x [ 2 ] h [ 2 , 0 ] + x [ 1 ] h [ 1 , 1 ] + x [ 0 ] h [ 0 , 2 ]$$

$$y [ 3 ] = x [ 3 ] h [ 3 , 0 ] + x [ 2 ] h [ 2 , 1 ] + x [ 1 ] h [ 1 , 2 ]$$

$$y [ 4 ] = x [ 4 ] h [ 4 , 0 ] + x [ 3 ] h [ 3 , 1 ] + x [ 2 ] h [ 2 , 2 ]$$

$$⋮$$

$$y [ M - 1 ] = x [ M - 1 ] h [ M - 1 , 0 ] + x [ M - 2 ] h [ M - 2 , 1 ] + x [ M - 3 ] h [ M - 3 , 2 ]$$

$$y [ M ] = x [ M - 1 ] h [ M - 1 , 1 ] + x [ M - 2 ] h [ M - 2 , 2 ]$$

$$y [ M + 1 ] = x [ M - 1 ] h [ M - 1 , 2 ]$$

The output signal y[m] is held for use at the output of the programmable circuit. The values of the output signal are generally complex numbers. The complex number values are transformed in digital/analogue manner and supplied as I and Q signals to a modulator.

### SECOND EMBODIMENT OF THE INVENTION

In a second preferred embodiment of the invention, for each individual propagation path, in addition to the damping coefficients, the Doppler frequency and the delay an additional path parameter is determined, which specifies the increase or decrease in the damping in the propagation path concerned over the time. The addition of this path parameter results in a more precise modelling of the propagation path concerned.

If one assumes that the damping ηₚ[m] is determined depending on the time in the respective interval according to ηₚ[m]=aₚ+bₚ·m, the time-dependent part of the path transfer function g^{t}ₚ[m] can be shown as follows:

$$\begin{matrix}{g}_{p}^{t} [ m ] = {η}_{p} [ m ] {e}^{j 2 π {v}_{p} m} \\ = {a}_{p} {e}^{j 2 π {v}_{p} m} + {b}_{p} {me}^{j 2 π {v}_{p} m} \\ = {a}_{p} c + {b}_{p} l\end{matrix}$$

The sum here resulting comprises a first summand

c=e^{j2πv}^{ₑ}^{m}

the Doppler vector of which, as denoted in the case of the first embodiment of the invention, can be determined by means of table lookup in the lookup table ┌ already described in connection with the first embodiment of the invention.

The calculation of the second summand

l=me^{j2πv}^{ₚ}^{m}

can in the same way take place by means of a table lookup in a second lookup table ┌′. The determining of the individual coefficients of the second lookup table ┌′ is here undertaken analogously to the determination of the coefficients of the first lookup table ┌, and a further Doppler vector γ″ₚ is obtained.

Alternatively, in addition to the determining of the further Doppler vector γ″ₚ by means of table lookup, there is also the possibility of calculating the individual Doppler vectors by means of the following rule:

γ″ₚ=U^{H}diag(m)Uγ′ₚ

m=0, 1, . . . , M−1

The matrix diag(m) denotes here a diagonal matrix in the diagonal entries of which the entries of the vector m=[0, 1, . . . , M−1] are included. The matrix U here denotes the matrix of the base functions, the matrix U^{H} is the conjugate transpose of the matrix U.

In order to be able to carry out the calculation more quickly, a transformation matrix Uₜᵣ in the following format can be calculated in advance.

Uₜᵣ=U^{H}diag(m)U

The further Doppler vector can in this case be determined as follows.

γ″ₚUₜᵣγ′ₚ

The path matrix ψₚ can be determined as follows starting from γ′ₚ, γ″ₚ and ε′ₚ.

Ψₚ=(aₚγ′ₚ+bₚγₚ^{H})⊗εₚ^{fτ}

The further procedure, in particular the determining of the summed matrix, the transfer matrix and the transfer function and of the output signal, is equal to the procedure of the first embodiment of the invention. In a preferred further development of the invention, there is the possibility of avoiding individual phase jumps which result by means of the different selection of the Doppler frequency in the individual time segments. Here it can be provided that the phase position at the end of the time segment concerned is present at the start of the respectively following time segment.

For this purpose, for each individual propagation path P the phase position at the end of the respectively antecedent time segment is determined and set at the respectively subsequent time segment as an initial value. For the S-te time interval, the initial phase position ϕ_{p,S} can be determined using the following rule, wherein ϕ_{p,S-1} determines the respective initial phase position ϕ_{p,S-1} of the respectively antecedent time interval, wherein the phase shift vₚ·M caused by the Doppler frequency is added:

ϕ_{p,S}=ϕ_{p,S-1}+v_{p,S-1}M

In this context, M denotes the number of the discrete time points within the time segment concerned. The initial phase position is separately calculated for each propagation path and for each time segment and is taken into consideration at the formation of the path matrices ψₚ as follows:

Ψ′ₚ=(aₚγ′ₚ+bₚγₚ^{H})⊗εₚ^{fτ}e^{jϕp,3}

A possible implementation of the phase adjustment provides concretely, for each individual propagation path, in each case the caching of the initial phase shift at the start of the actual time segment and the actualising of the initial phase position concerned after the end of the time segment, as described previously.

We claim:

1. A method for emulating a radio channel between a movable transmitter and a movable receiver, which are respectively connected to at least one antenna, in a predeterminable environment influencing the radio channel,
wherein for a number of consecutive time segments
respectively the relative position and relative movement upon which the emulation is based, and where appropriate relative orientation and relative rotation, of the two antennas to one another is predetermined, wherein the temporal change of the relative position and relative movement is predetermined in advance and in particular follows physical laws,
wherein on the basis of the relative position and relative movement and where appropriate relative orientation and relative rotation and on the basis of the predetermined environment a number of propagation paths (P₀, P₁, . . . , P_{P-1}) running between the antennas is determined, wherein for each of the propagation paths (P₀, P₁, . . . , P_{P-1}) a damping factor (ηₚ), a delay (θₚ) and a Doppler frequency (vₚ) are separately ascertained,
characterised in that starting from the individual propagation paths (P₀, P₁, . . . , P_{P-1}) for a number of consecutive time segments in each case
for each propagation path (P₀, P₁, . . . , P_{P-1}) by means of separate table lookup for the delay and the Doppler frequency in each case one coefficient vector (γ′ₚ, ε′ₚ) is produced and with these coefficient vectors by forming the Kronecker product a path matrix (ψₚ) is produced, and the path matrices (ψₚ) thus produced of the individual propagation paths (P₀, P₁, . . . , P_{P-1}) are weighted with the respective damping (ηₚ) of the propagation path (P₀, P₁, . . . , P_{P-1}) and are summed,
starting from the summed matrix (ψ) thus produced by means of a linear transformation a transfer matrix (Y) is determined, wherein the transformation reduces that, in particular exclusively that, dimension of the transfer matrix (Y) with respect to the summed matrix (ψ), which is equal to the coefficient vector (ε′ₚ) of the delay, and
the transfer matrix (Y) is transferred to the programmable circuit (20),
wherein in the programmable circuit (20) a number of discrete base functions, characterising the time variance of the transfer functions and/or the impulse response, is predetermined as base matrix (U),
wherein the time-variable impulse responses of the respective time segment are determined by multiplying the transfer matrix (Y) with the base matrix (U),
wherein the signal generated by the transmitter is sampled at an input and digitalised and in such a manner a discrete input signal (x) is generated,
wherein the discrete input signal (x) is folded with a time-variable impulse response (h) from a digital circuit and in such a matter a discrete output signal (y) is generated, and
that in particular starting from the discrete output signal (y) a time-and-value-continuous output signal is generated.

2. The method according to claim 1,
wherein for the individual consecutive time segments the damping for the individual propagation paths (P₀, P₁, . . . , P_{P-1}) is predetermined with linear dependency on the discrete time, wherein as path parameters for the damping a constant term (aₚ) and a time-dependent term (bₚ) are predetermined,
wherein for each time segment and for each propagation path (P₀, P₁, . . . , P_{P-1})
by means of separate table lookup of the delay a delay vector (ε′ₚ) is produced and by means of separate table lookup of the Doppler frequency a Doppler vector (γ′ₚ) is produced,
on the basis of the Doppler frequency a further Doppler vector (γ″ₚ) is generated:
by means of table lookup in a further lookup table, or
by means of determination on the basis of the following rule,
γ″ₚ=U^{H}diag(m)Uγ′ₚ
wherein the matrix diag(m) describes a diagonal matrix in the diagonal entries of which are contained the entries of the vector m=[0, 1, . . . , M−1], the matrix U designates the matrix of the base functions and the matrix U^{H} designates the conjugated transpose of the matrix U,
the Kronecker product of the delay vector (ε′ₚ) and of the Doppler vector is formed and weighted with the constant term of the damping and,
the Kronecker product of the delay vector (ε′ₚ) and of the further Doppler vector is formed and weighted with the time-dependent term of the damping, and
the path matrix (ψₚ) is calculated as sum of these Kronecker products.

3. The method according to claim 1, characterised in
that for the individual time segments for each individual propagation path (P₀, . . . , P_{P-1}) in each case at the start of the actual time segment a present initial phase shift (φ_{p,S-1}) is kept available and in each case after the end of the time segment an initial phase shift (φ_{p,S}) is determined for the following time segment according to
ϕ_{p,S}=ϕ_{p,S-1}+v_{p,S-}M
wherein v_{p,S-1} describes the Doppler frequency in the respectively preceding time segment and M specifies the length of the time segments, and
that in the determination of the path matrix (φₚ) for the individual propagation paths (P₀, P₁, . . . , P_{P-1}) a phase correction is undertaken corresponding to the respective initial phase shift (φ_{p,S}), in particular by weighting or multiplication with e^{j φp,S}.

4. The method according to claim 2, characterised in
that for the individual time segments for each individual propagation path (P₀, . . . , P_{P-1}) in each case at the start of the actual time segment a present initial phase shift (φ_{p,S-}) is kept available and in each case after the end of the time segment an initial phase shift (φ_{p,S}) is determined for the following time segment according to
ϕ_{p,S}=ϕ_{p,S-1}v_{p,S-1}M
wherein v_{p,S-1} describes the Doppler frequency in the respectively preceding time segment and M specifies the length of the time segments, and
that in the determination of the path matrix (ψₚ) for the individual propagation paths (P₀, P₁, . . . , P_{P-1}) a phase correction is undertaken corresponding to the respective initial phase shift (φ_{p,S}), in particular by weighting or multiplication with e^{j φp,S}.
